(19) United States
(12) Patent Application Publication
(10) Pub. No.: US 2010/0017415 A1
(43) Pub. Date: Jan. 21, 2010

(54) DATA ACCESS CONTROL METHOD AND DATA ACCESS CONTROL APPARATUS

(75) Inventors: Noboru Kurumai, Kawasaki (JP); Takeo Yasukawa, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/498,728

(22) Filed: Jul. 7, 2009

(30) Foreign Application Priority Data
Jul. 16, 2008 (JP) 2008-185108

(51) Int. Cl. G06F 17/30

(52) U.S. Cl. 707/10; 707/E17.032; 707/9; 707/E17.005

(57) ABSTRACT

A data access control apparatus and method acquires a user identification (ID) of a user who uses a client device based on a login request received from the client device, and a tenant ID for the user ID from a tenant ID management storage unit that associates user IDs with tenant IDs and records the association. An application software is activated depending on a processing request received from the client device and an access unit which receives an access request for a database from the application software and transmits the access request for a data area for the tenant ID among a plurality of data areas in the database to a database management unit based on the tenant ID recorded in the identification storage unit.

### CROSS-REFERENCE TO RELATED APPLICATIONS

This application is based upon and claims the benefit of priority of the prior Japanese Patent Application No. 2008-185108, filed on Jul. 16, 2008, the entire contents of which are incorporated herein by reference.

### BACKGROUND

1. Field

Certain aspects of the present invention discussed herein are related to a data access control method and a data access control apparatus, and more particularly to data access control method and the data access control apparatus for a database.

2. Description of the Related Art

Conventionally, in Web applications provided by an Application Service Provider (ASP), a Web server customizes one application for each of users to satisfy the needs depending on users. The reference to users herein may mean companies, associations, and public offices that have service contracts with an ASP.

A system configuration that is called Software as a Service (SaaS) has attracted attention these days. The SaaS operates the same Web application on the same server and allows a plurality of users to use the same Web application, thereby reducing the operation cost.

Similar known techniques include Japanese Laid-open Patent Publication No. 2004-310356.

### SUMMARY

According to an aspect of the invention, a data access control apparatus coupled to a client device via a network includes an identification information recording unit which acquires a user identification (ID) of a user who uses the client device based on a login request received from the client device, and a tenant ID for the user ID from a tenant ID management storage unit that stores association of user IDs with tenant IDs and records the user ID and the tenant ID in an identification storage unit. An aspect of the invention includes an application software activation unit which activates an application software depending on a processing request received from the client device and an access unit which receives an access request for a database from the application software and transmits the access request for a data area for the tenant ID among a plurality of data areas in the database to a database management unit based on the tenant ID recorded in the identification storage unit.

The disclosed invention includes acquiring an identification of a user based on a login request and a tenant identification for the user, activating an application software depending on a processing request received and receiving an access request for a database from the application software and transmitting the access request for a data area for the tenant identification among a plurality of data areas in the database to a database management unit based on the tenant identification recorded in a identification storage unit.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates an example of a system configuration of an embodiment;

FIG. 2 illustrates an example of table configuration(s) in a business database (DB);

FIG. 3 illustrates an example of a hardware configuration of a Web server according to an embodiment;

FIG. 4 is a flow chart illustrating processing procedure(s) by a Web server;

FIG. 5 illustrates an example of a tenant ID management table configuration;

FIG. 6 illustrates processing of accessing a business DB by a database access unit when a parent-child relationship exists between tenants; and

FIG. 7 illustrates an example of a configuration of a parent-child relationship management table.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

When a Web application for an information management system using a database is provided by Software as a Service (SaaS), it is desirable that information managed by the database is appropriately separated for each user in terms of security etc. and more specifically, a different database area be provided for each user.

However, various Web applications exist that use the database. Thus, there is a drawback that implementing logic in each Web application to judge a data area for each user and to access the data area complicates the development work and increases the cost.

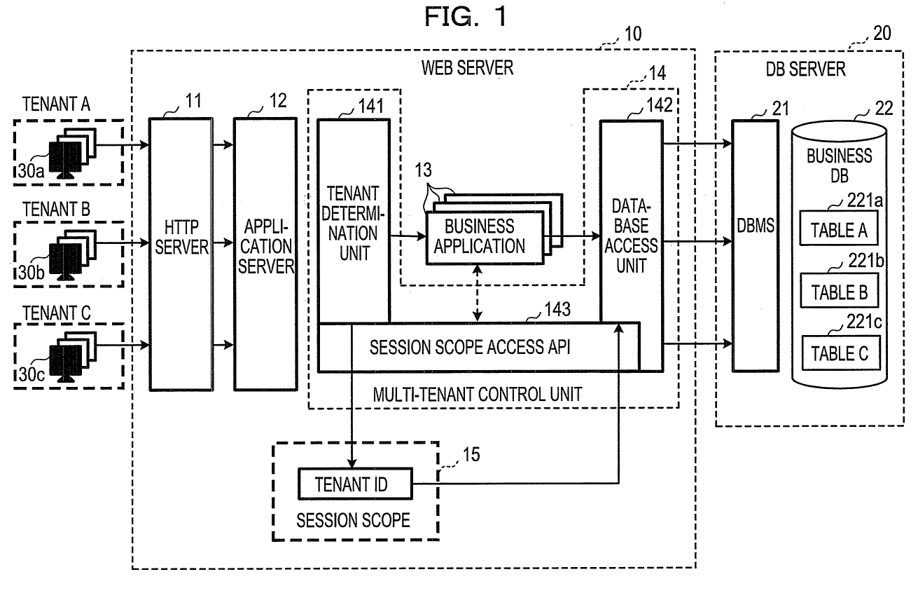

Now, embodiments of the present disclosure will be described based on drawings. FIG. 1 illustrates an example of a system configuration of an embodiment.

In FIG. 1, a Web server 10 and a database (DB) server 20 are computers that belong to a service provider. The service provider provides service(s) by function(s) of application software (hereinafter, simply described as “application” for explanatory purposes) in the form of Software as a Service (SaaS) to tenants, which will be described in detail below. Client devices 30a, 30b, and 30c etc. (hereinafter, called “client device 30” if collectively described) are computers that belong to service users. For example, the client device 30a belongs to a tenant “A”, the client device 30b belongs to a tenant “B”, and the client device 30c belongs to a tenant “C.” A tenant in this embodiment refers to a user, an entity, a company or an association that has a service contract with a service provider. Thus, the tenant includes one user or more. Further, a tenant may also refer to a group of users who are assigned to be provided the same or similar service and/or information.

The DB server 20 includes a Database Management System (DBMS) 21 and a business database (DB) 22.

The business DB 22 is a database that systematically manages information to be managed by a business application 13. In FIG. 1, the business DB 22 includes a table A 221a, a table B 221b, and a table C 221c (hereunder, called “table 221” if collectively described). In this case, the table A 221a is a table for the tenant “A” (data management area), the table B 221b is a table for the tenant “B”, and the table C 221c is a table for the tenant “C.” As described above, in the business DB 22, data areas are clearly separated for and correspond to each tenant. Although a specific number of tenants and corresponding tables are illustrated in FIG. 1, the present invention is not limited to particular number of tenants or corresponding information and tables.

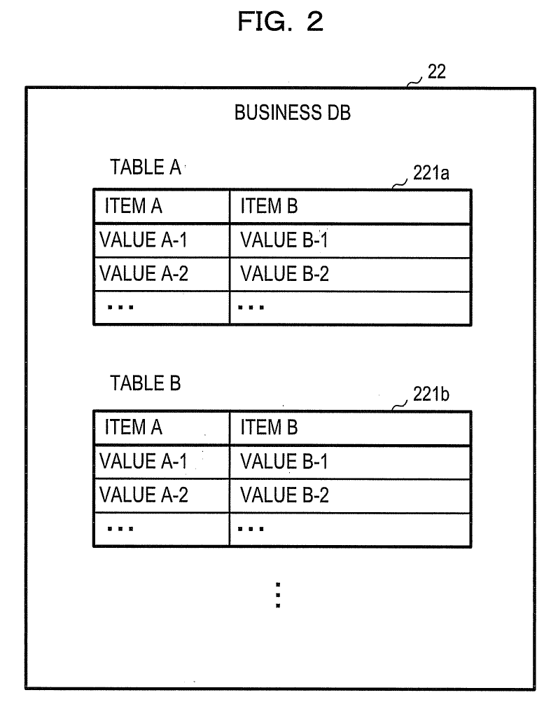

FIG. 2 illustrates an example of table configuration(s) in a business database (DB). In FIG. 2, for convenience of explanation, examples of configurations of the table A 221a and the table B 221b are illustrated. In FIG. 2, a schema (structure) of each table is the same. In other words, either of records in the table A 221a and table B 221b includes an item “A” and an item “B.” Note that schemas in each of the table 221 may not be necessarily the same.

The DBMS 21 (FIG. 1) is a database management unit (DBMS), and may be used for example, to perform processing for the DB 22 according to an input of Structured Query Language (SQL).

The Web server 10 is an example of a data access control apparatus, and may include software such as those implemented using a HyperText Transfer Protocol (HTTP) server 11, an application server 12, a business application 13, and a multi-tenant control unit 14.

The HTTP server 11 controls communication between the client device 30. For example, the HTTP server 11 receives a request (a HTTP request) from the client device 30 and transmits a response for the request (a HTTP response).

The application server 12 activates (calls) a business application 13 depending on the request (based on the Uniform Resource Locator (URL)) from the client device 30.

The business application 13 is a Web application. The plurality of business applications 13 may exist depending on functions. Each business application 13 according to an embodiment provides information management functions using the DB server 20. Moreover, each business application 13 is commonly used by a plurality of tenants.

The multi-tenant control unit 14 controls which table 221 in the business DB 22 is to be accessed in response to a request from a client device 30 that belongs to each tenant. The multi-tenant control unit 14 provides the above control system to each business application 13. In other words, the control system makes a correspondence relationship between a tenant and a table 221 transparent to each business application 13.

The multi-tenant control unit 14 includes a tenant determination unit 141, a database access unit 142, and a session scope access Application Program Interface (API) 143. The tenant determination unit 141 determines a tenant to which a client device 30 (a user) that is a transmission source of the HTTP request belongs based on information included in the HTTP request received by the HTTP server 11. The database access unit 142 provides an interface (a function or a method) for accessing the DBMS 21 to the business application 13. The database access unit 142 generates a SQL statement, for example, for an access request to the DBMS 21 via the interface and transmits the statement to the DB server 20. In this case, the database access unit 142 accesses a table 221 for the tenant determined by the tenant determination unit 141.

The session scope access API 143 is a set of functions that enables access to the session scope 15. According to an embodiment, a “session scope” is data generated in a memory device 103 for managing session(s) between client device 30, and generally referred to as a session object. For example, a tenant determination unit 141 records (registers) information for identifying a tenant (hereunder, called as a “tenant ID”) obtained as a determination result in a session scope 15 using the session scope access API 143. The tenant ID is uniquely assigned to each tenant. The database access unit 142 acquires a tenant ID registered in the session scope 15 using the session scope access API 143.

The Web server 10 and the DB server 20 are coupled via a network such as a Local Area Network (LAN) or the Internetwork (regardless of wired or wireless connection). The client device 30 and the Web server 10 are coupled via a network such as the Internet.

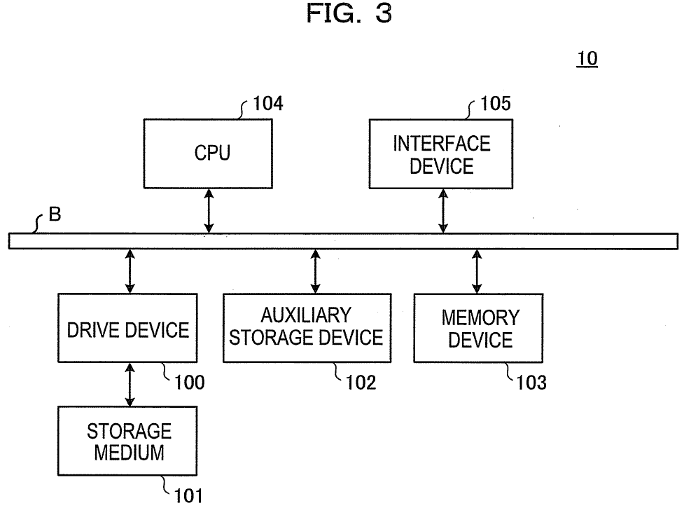

FIG. 3 illustrates an example of a hardware configuration of a Web server according to an embodiment. A Web server 10 in FIG. 3 has a drive device 100, an auxiliary storage device 102, a memory device 103, a CPU 104, and an interface device 105 that are interconnected by a bus B.

A program that enables processing at the Web server 10 is provided by a computer-readable storage medium 101 such as a compact disk read only memory (CD-ROM), etc. When the storage medium 101 that stores a program is set to a drive device 100, the program is installed to the auxiliary storage device 102 via the drive device 100. Note that the program is not necessarily installed from the storage medium 101, and may be downloaded from another computer via a network. The auxiliary storage device 102 stores the installed program and required files and data etc. as well.

The memory device 103 stores the program read from the auxiliary storage device 102 upon receiving an instruction to activate the program. The CPU 104 executes functions of the Web server 10 according to the program stored in the memory device 103. The interface device 105 is used as an interface to connect to a network.

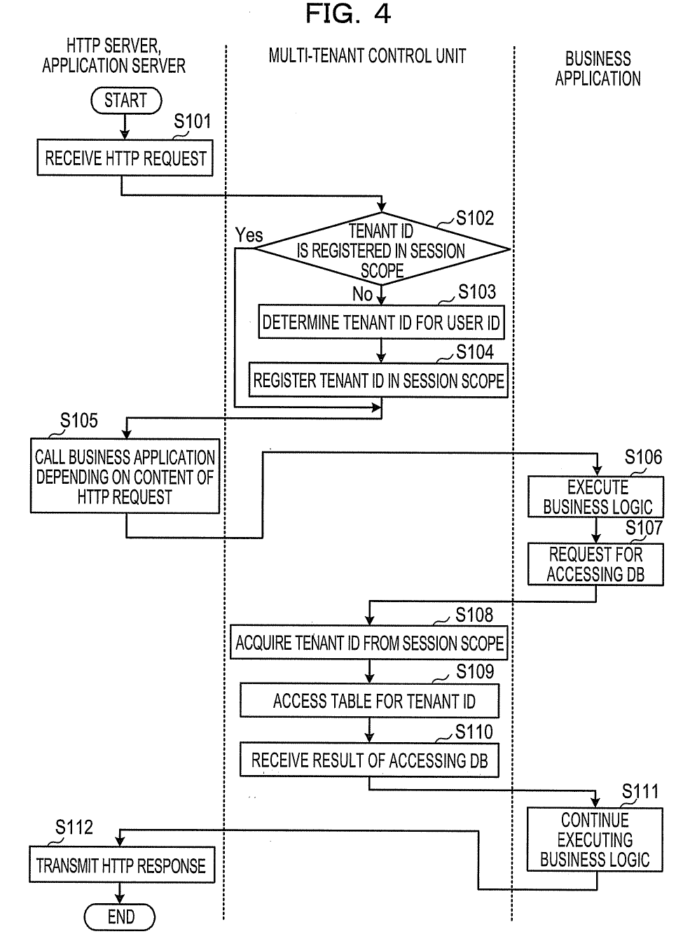

Now, processing procedures of the Web server 10 will be described. FIG. 4 is a flow chart illustrating processing procedures by the Web server.

In response to an HTTP request received by the HTTP server 11 from the client device 30 (S101), the tenant determination unit 141 determines whether or not a tenant ID is registered in a session scope 15 for a session with the client device 30 (S102).

Each session is identified by a session ID. The session ID is assigned by an application server 12 when a session is established, and transmitted to the client device 30. The client device 30 stores the session ID in Cookie or other identifier, etc. and transmits the session ID to the Web server 10 for each HTTP request. The session scope 15 is generated by the application server 12 together with the session ID upon establishing the session. The session scope 15 is managed by being linked with the session ID. Thus, the tenant determination unit 141 may acquire the session scope 15 for a current session based on the session ID.

According to an aspect of an embodiment, a state in which no tenant ID is registered in the session scope 15 means that the received HTTP request is a login request. The login request includes a user ID (ID that identifies each user) and a password input at a login screen displayed on a Web browser of the client device 10. Then, in this case (S102: No), the tenant determination unit 141 determines a tenant ID for the user ID included in the HTTP request (login request) based on a tenant ID management table (S103).

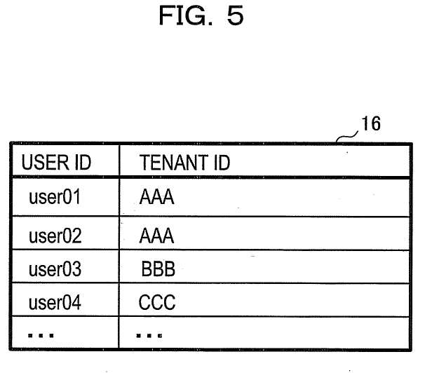

FIG. 5 illustrates an example of a tenant ID management table configuration. As illustrated in FIG. 5, a tenant ID management table 16 registers correspondence information of a user ID and a tenant ID. When a user ID included in a login request is “user 01”, the tenant determination unit 141 determines the corresponding tenant ID is “AAA.”

Subsequently, the tenant determination unit 141 registers the tenant ID as the determination result to the session scope 15 (S104).

If the tenant ID has already been registered in the session scope (in other words, the HTTP request asks to execute a business logic other than a login request) (S102: Yes), Operations S103 and S104 illustrated in FIG. 4 are not required to be performed.

Subsequently, the application server 12 determines and calls (activates) a business application 13 depending on content of the HTTP request (for example, a URL included in the HTTP request) (S105). Determination of a business application 13 depending on content of a HTTP request may be performed, for example, based on correspondence information between URLs and business applications 13 stored in an auxiliary storage device 102.

Then, the called business application 13 executes business logic implemented therein (S106). In the process of executing the business logic, the business application 13 requests to a database access unit 142 for accessing (operations such as data search, register, update, or deletion) a business DB 22 (S107). At this time, the business application 13 does not involve in determining a table for which tenant is to be accessed. For example, as illustrated in FIG. 1 and FIG. 2, when one table 221 exists for each tenant, the business application 13 does not designate a table name to be accessed. When a plurality of table 221 exist for each tenant (for example, each tenant has a product information table and a customer information table), the business application 13 only designates a table to be accessed is whether the product information table or the customer information table, and does not designate the table 221 for which tenant is accessed.

Subsequently, the database access unit 142 acquires a tenant ID from the session scope 15 (S108). The tenant determination unit 141 and the database access unit 142 operate in the same thread. Thus, the database access unit 142 may refer to the session scope 15 acquired in the thread space by the tenant determination unit 141.

Then, the database access unit 142 determines a table 221 to be accessed based on a table 221 for the acquired tenant ID. The database access unit 142 generates a SQL statement for executing an access to the determined table 221 requested by the business application 13, and transmits the SQL statement to a DBMS 21 (S109). Determination of a table 221 to be accessed based on a tenant ID may be performed based on correspondence information between each tenant ID and a name for each table 221 stored in an auxiliary storage device 102. If each table name matches each tenant ID, the tenant ID may be determined as a table name in a SQL statement.

The DBMS 21 accesses or operates the business DB 22 according to the SQL statement. Thus, the DBMS 21 accesses a table 221 for a tenant that transmits a HTTP request.

Subsequently, when the database access unit 142 receives a result of accessing the business DB 22 (for example, a search result) from the DBMS 21, the database access unit 142 notifies the result to the business application 13 (S110)(receives a result of accessing the DB). Then, the business application 13 continues executing the business logic using the access result, and generates HyperText Markup Language (HTML) data that displays the result of the business logic (S111)(continues executing business logic). After that, a HTTP server 11 transmits the HTML data generated by the business application 13 by including the data in a HTTP response to the client device 30(S112).

As described above, according to a Web server 10 of an embodiment, the multi-tenant control unit 14 determines an ID of a tenant that is a source of a HTTP request and a table 221 for the tenant ID. Thus, there is no need to implement logic to determine a tenant ID and a table in each business application 13 that is commonly used by a plurality of tenants. This simplifies development work of each business application 13.

In the above example, the tenant determination unit 141 determines a tenant ID for a user ID; however, the database access unit 142 may perform the determination instead. In this case, the tenant determination unit 141 may register a user ID in a session scope 15. The database access unit 142 may determine a tenant ID based on a user ID and a tenant ID management table 16 registered in a session scope 15.

Information that is associated with a tenant ID in the tenant ID management table 16 may not be a user ID, but any identification information for each client device 30.

Moreover, when a tenant ID and a password are specified instead of a user ID and a password at login (in other words, users who belong to the same tenant logs in with the same tenant ID), a tenant ID management table 16 is not required.

There is a case in which a parent-child relationship (subordination) exists between tenants. For example, when tenants are for a company, a tenant for the parent company and a plurality of tenants for subsidiaries of the company may exist. Moreover, when tenants are for organizations within one company, tenants for departments, and a plurality of divisions that belong to the departments may exist. As described above, when a parent-child relationship exists between tenants, it is convenient if the parent tenant may collectively access the table 221 of the plurality of child tenants. Relationships may also exist where tenant(s) are provided with different levels of service (or information) based on relationship information.

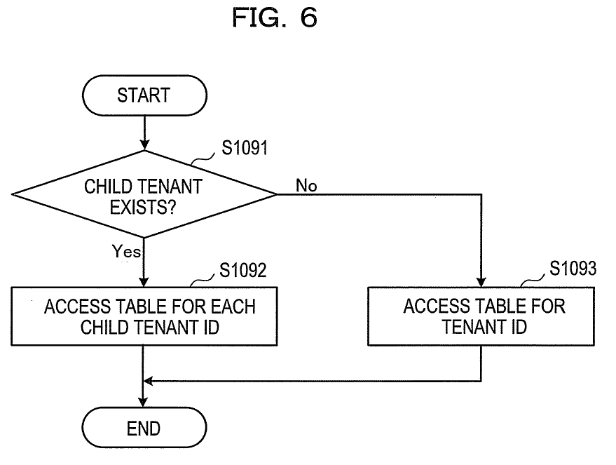

To enable this function, the operation S109 in FIG. 4 may be changed as follows. FIG. 6 illustrates processing of accessing the business DB by a database access unit when a parent-child relationship exists between tenants.

In operation S1091 in FIG. 6, it is judged whether or not a child tenant exists for a tenant corresponding to the tenant ID acquired from a session scope 15. The determination may be made based on a parent-child relationship management table recorded in an auxiliary storage device 102.

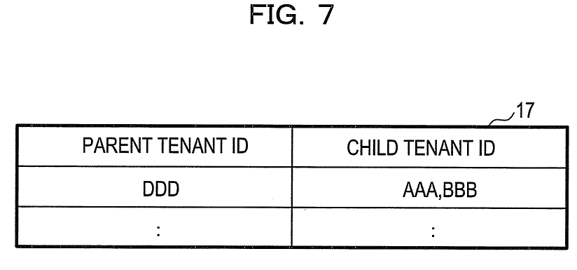

FIG. 7 illustrates an example of a configuration of a parent-child relationship management table. In FIG. 7, the parent-child relationship management table 17 registers, for each tenant ID of a tenant (parent tenant ID) that has a child tenant or more, a list of tenant IDs (IDs of tenants that belong to the parent tenant ID) of the child tenants.

In operation S1091, when the tenant ID acquired from the session scope 15 is registered as a parent tenant ID in the parent-child relationship management table 17, it is determined that the child tenant(s) exists. Moreover, when the tenant ID acquired from the session scope 15 is not registered in the parent-child relationship management table 17 as a parent tenant ID, it is determined that no child tenant exists.

If it is determined that any child tenant exists, the same processing as the operation S109 in FIG. 4 will be performed for each table 221 for each child tenant ID registered in the parent-child relationship management table 17 (S1092).

If it is determined that no child tenant exists, the same processing as the operation S109 in FIG. 4 will be performed for the table 221 for a tenant ID acquired from the session scope 15 (S1093).

If a plurality of child tenants exists, and an access request is for a search then the search is performed for each table 221 for each child tenant, and the result is acquired. In this case, the database access unit 142 may output the search result to the business application 221 as it is or by merging the results.

Merging the search result is convenient, for example, when a parent company (or a department) provides a total value such as sales amount of the subsidiaries (or a division) to the parent tenant.

Any or all of the operations described herein may be implemented via one or more hardware components. However, the present invention is not limited to any specific implementation of an operation. For example, one or more operations discussed herein may be implemented via software executed on a device while others may be executed via a specific hardware device.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although a few embodiment(s) of the present invention(s) has (have) been described in detail, it should be understood that the various changes, substitutions, and alterations could be made hereto without departing from the spirit and scope of the invention, the scope of which is defined in the claims and their equivalents.

What is claimed is:

1. A data access control method executed by a computer coupled to a client device via a network, comprising:
acquiring a user identification of a user who uses the client device based on a login request received from the client device and a tenant identification for the user identification from a tenant identification management storage that stores association of user identifications with tenant identifications, and recording the user identification and the tenant identification in an identification storage unit;
activating an application software depending on a processing request received from the client device; and
receiving an access request to a database from the application software and transmitting the access request for a data area for the tenant identification among a plurality of data areas in the database to a database management unit based on the tenant identification recorded in the identification information storage unit.

2. The data access control method according to claim 1, wherein the tenant identification is recorded in the identification information storage unit as a part of data for managing a session between the computer and the client.

3. The data access control method according to claim 1, wherein a plurality of child tenants identifications that are subordinate to the tenant identification recorded in the identification information storage unit are acquired using a parent-child relationship storage unit that stores subordination of the tenant identifications, transmits access requests for data areas for the plurality of child identifications to a database management unit, and replies to the application software by merging the results of the access requests.

4. A data access control apparatus coupled to a client device via a network, comprising:
an identification information recording unit which acquires a user identification of a user who uses the client device based on a login request received from the client device, and a tenant identification for the user identification from a tenant identification management storage unit that stores association of user identifications with tenant identifications and records the user identification and the tenant identification in an identification storage unit;
an application software activation unit which activates an application software depending on a processing request received from the client device; and
an access unit which receives an access request for a database from the application software and transmits the access request for a data area for the tenant identification among a plurality of data areas in the database to a database management unit based on the tenant identification recorded in the identification storage unit.

5. A computer-readable recording medium recording a program that causes a computer coupled to a client device via a network to execute to perform a process comprising;
acquiring a user identification of a user who uses the client device based on a login request received from the client device, and a tenant identification for the user identification from a tenant identification management storage unit that stores association of user identifications with tenant identifications, and recording the user identification and the tenant identification in an identification information storage unit;
activating an application software depending on a processing request received from the client device; and
receiving an access request for a database from the application software and transmitting the access request for a data area for the tenant identification among a plurality of data areas in the database to a database management unit based on the tenant identification recorded in the identification storage unit.

6. A computer implement method of data access, comprising:
determining a session scope based on a request received from a user; and
providing a service defined by the session scope as a response to the request based on association of an identifier of the user with an area among multiple areas of a database commonly shared by multiple users.
